(19) United States
(12) Patent Application Publication
(10) Pub. No.: US 2007/0266408 A1
(43) Pub. Date: Nov. 15, 2007

(54) RECORDING APPARATUS AND RECORDING METHOD

(75) Inventor: Kengo Takeuchi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/744,363

(22) Filed: May 4, 2007

(30) Foreign Application Priority Data
May 9, 2006 (JP) 2006-130098
Feb. 16, 2007 (JP) 2007-037003

(51) Int. Cl. H04N 7/20

(52) U.S. Cl. 725/71

(57) ABSTRACT

A recording apparatus includes a recording unit, a determination unit, a generation unit, an identification unit, and a control unit. The recording unit records image data on a recording medium. The determination unit determines plural recording media to be allocated to a same group. The generation unit generates order information indicating an order of each recording medium in the group. The order information includes identification information identifying each recording medium. The identification unit identifies a recording medium in the group based on the identification information. The control unit controls the recording unit to record, on each of the plural recording media belonging to the same group, information representing an order of the identified recording medium in the group and information representing a total number of the recording media belonging to the same group, based on an identification result obtained by the identification unit and the order information.

### BACKGROUND OF THE INVENTION

1. Field of the Invention

The present invention relates to a recording apparatus and a recording method. More particularly, the present invention relates to a technique for recording image signal on plural recording media.

2. Description of the Related Art

Video cameras can capture moving images of an object and record the captured image signal on a magnetic tape or a memory card. Disk video cameras can record a captured image signal on a digital versatile disk (DVD) or other optical disk or a hard disk (as discussed in Japanese Patent Application Laid-open No. 2005-79823 corresponding to United States Published Application 2006/0140587A1).

For example, a video camera having recording/playback capability enables a user to record, on a disk (DVD), approximately 30 minutes of image signals having a standard image quality together with audio signals. However, if a shooting target is a long-lasting event (e.g., a wedding ceremony or a sports meeting), the recording amount for sequential moving images throughout an event may exceed the capacity of one disk. Therefore, two or more disks may be required to completely record sequential moving images relating to a same event.

As discussed in Japanese Patent Application Laid-open No. 2005-79823, the finalization processing for a recording medium can include generation of a top menu that indicates information relating to each chapter contained in the recording medium. However, the following problems may arise.

If a playback operation of the sequential moving images of a same event ranges over a plurality of disks, a user may not be able to identify the order of respective disks. Therefore, a user is required to check the contents of all disks. As a result, a playback operation for an intended disk cannot be started before completing a time-consuming operation for confirming the contents of each disk.

### SUMMARY OF THE INVENTION

Exemplary embodiments of the present invention are directed to a technique capable of easily confirming the order of each recording medium when the recording of image data requires a plurality of recording media.

According to an aspect of the present invention, a recording apparatus includes a recording unit configured to record image data on a recording medium; a determination unit configured to determine a plurality of recording media to be allocated to a same group; a generation unit configured to generate order information indicating an order of each recording medium in the group, the order information including identification information identifying each recording medium; an identification unit configured to identify a recording medium in the group based on the identification information; and a control unit configured to control the recording unit to record, on each of the plurality of recording media belonging to the same group, information representing an order of the identified recording medium in the group and information representing a total number of the recording media belonging to the same group, based on an identification result obtained by the identification unit and the order information generated by the generation unit.

According to another aspect of the present invention, a recording apparatus includes: a recording unit configured to record image data on a loaded recording medium; a setting unit configured to set a relay recording mode according to which a plurality of recording media are regarded as belonging to a same group; a generation unit configured to allocate a plurality of recording media to a same group if the plurality of recording media are loaded in a period from setting of the relay recording mode by the setting unit to cancellation of the relay recording mode, and generate order information representing a loading order of the recording medium in the group; an identification unit configured to identify a recording medium in the group; and a control unit configured to control the recording unit to record, on each of the plurality of recording media belonging to the same group, information representing an order of the identified recording medium in the group and information representing a total number of the recording media belonging to the same group, based on an identification result obtained by the identification unit and the order information generated by the generation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a video camera according to an exemplary embodiment.

FIG. 2 is a flowchart illustrating an exemplary operation of the video camera in a relay recording mode.

FIG. 3 is a flowchart illustrating exemplary finalization processing.

FIGS. 4A and 4B illustrate exemplary recording states of plural disks.

FIG. 5 illustrates various messages displayed on the video camera according to an exemplary embodiment.

FIG. 6 illustrates title menus of plural disks generated according to an exemplary embodiment.

FIG. 7 is a flowchart illustrating preparation processing according to an exemplary embodiment.

FIG. 8 illustrates an example of order information.

### DETAILED DESCRIPTION OF THE EMBODIMENTS

The following description of exemplary embodiments is merely illustrative in nature and is in no way intended to limit the invention, its application, or uses.

Processes, techniques, apparatus, and systems as known by one of ordinary skill in the art may not be discussed in detail but are intended to be part of the enabling description where appropriate.

For example, certain circuitry for image processing, data processing, and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is described in one figure, it may not be discussed for following figures.

Exemplary embodiments will be described in detail below with reference to the drawings.

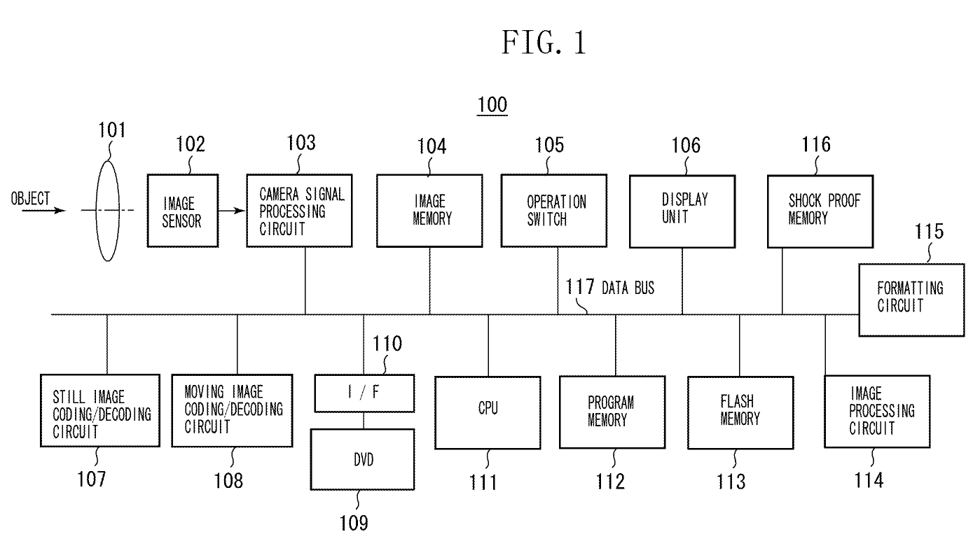

FIG. 1 is a block diagram illustrating an exemplary arrangement of a camera-integrated moving image recording/playback apparatus (video camera) 100. When the video camera 100 starts an operation, a compressed program in a flash memory 113 is decompressed and expanded in a program memory 112. CPU 111 executes various control operations according to the program stored in the program memory 112.

The light from an object, after passing through a lens unit 101, can be captured by an image sensor 102. The image sensor 102 converts an object image (i.e., an optical signal) into an electric signal. A camera signal processing circuit 103 reads a photoelectric conversion image from the image sensor 102 at predetermined intervals.

The camera signal processing circuit 103 can apply predetermined processing to the read signal and obtain a standard image signal. An image memory 104 temporarily stores a standard digital moving image resulting from the signal processing performed by the camera signal processing circuit 103.

The camera signal processing circuit 103 sends a digital moving image to a display unit 106. The display unit 106 can display a moving image of an object that is currently captured by a user (hereinafter, referred to as “shooting standby state”). The shooting standby state allows a user to start a shooting operation if the user presses a shooting button (not shown) included in an operation switch 105.

When the shooting operation starts, a moving image coding/decoding circuit 108 encodes the moving image data temporarily stored in the image memory 104 and sends the encoded moving image data to a formatting circuit 115. The formatting circuit 115 can convert the encoded moving image data into recording data having a suitable format and send the recording data to a shock proof memory 116. If a predetermined amount of data is stored in the shock proof memory 116, an interface (I/F) 110 reads the data from the shock proof memory 116 and records the read data on a DVD 109.

If the shooting button involved in the operation switch 105 is pressed again by a user, the interface 110 stops recording the data. Thus, the video camera 100 terminates recording of a moving image clip which can be referred to as “one-cut.”

On the other hand, if a user presses a still image shooting button during the above-described shooting standby state, moving image data corresponding to one screen is sent from the image memory 104 to a still image coding/decoding circuit 107. The still image coding/decoding circuit 107 encodes the received image data as a still image and sends the encoded still image to the shock proof memory 116. The I/F 110 can read the still image data from the shock proof memory 116 and record the read still image on the DVD 109. As illustrated in FIG. 1, the video camera 100 includes an image processing circuit 114 and a data bus 117.

The operation switch 105 allows a user to arbitrarily select a desirable image quality for a moving image to be recorded because plural image quality modes are provided beforehand. In the exemplary embodiment, a user can select one of two image quality modes (i.e., a standard quality mode and a high quality mode). The data rate for recording moving image data is lower in the standard quality mode compared to that in the high quality mode.

Therefore, compared to the high quality mode, the standard quality mode can provide a longer time for recording moving images on a disk. The flash memory 113 is capable of storing the information relating to the set image quality mode, even after the power source is turned off.

In the exemplary embodiment, the DVD 109 is a DVD-RW disk and a recording format is a DVD-video format or a DVD video recording (VR) format. An ejection mechanism (not shown) enables a user to load or unload a disk to or from the video camera 100. If a brand-new disk is loaded, the video camera 100 requests a user to select the format for recording image data between the DVD video format and the VR format.

A user can select a desirable recording format (i.e., can select either the DVD video format or the VR format) through the operation switch 105. The recording format set by a user is stored in the flash memory 113 and is not erased even after the power source is turned off. Furthermore, when a disk already storing image data is newly loaded, the video camera 100 can detect management information recorded on the disk and can identify the recording format (i.e., DVD video format or the VR format).

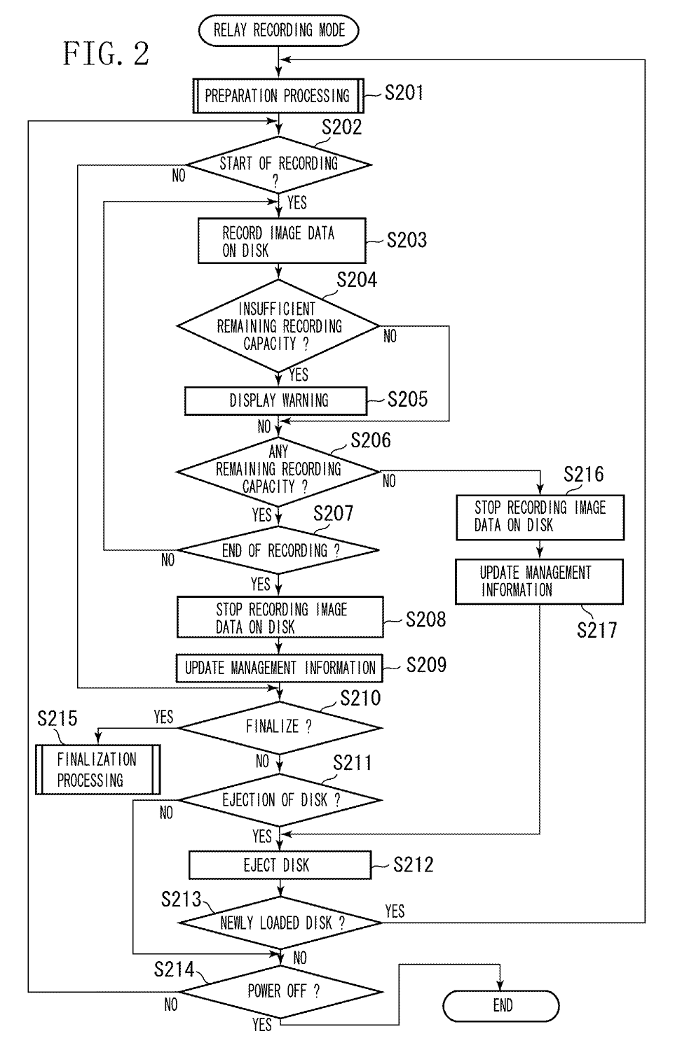

Next, an exemplary relay recording mode for the video camera 100 illustrated in FIG. 1 is described with reference to a flowchart illustrated in FIG. 2. According to the present embodiment, if recording of an event requires plural disks, the video camera 100 can operate in the relay recording mode that can manage the plural disks as belonging to a same group.

The operation switch 105 includes a relay recording mode switch that can set the relay recording mode if operated by a user. In the exemplary embodiment, the video camera 100 can record image data on a DVD-R disk or a DVD-RW disk based on the DVD video format.

The video camera 100 can perform finalization processing so that other DVD player can perform a playback operation for a disk storing image data recorded by the video camera 100 based on the DVD video format. Thus, in the exemplary embodiment, the video camera 100 allocates all (plural) disks to a same group if these disks are used to record image data during a period from operation of the relay recording mode switch to a finalization instruction, as described later.

FIG. 2 is a flowchart illustrating exemplary operation of the video camera 100 in the relay recording mode. The CPU 111 controls various sections of the video camera 100 to realize the processing illustrated in FIG. 2.

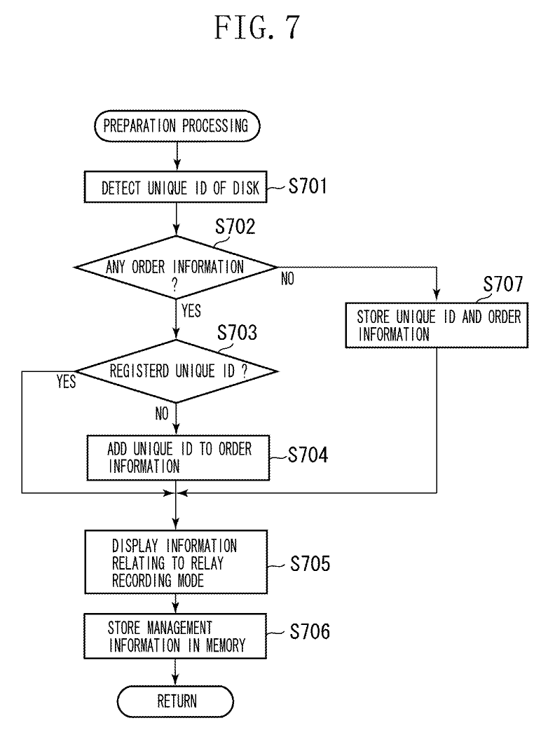

If a user operates the relay recording mode switch in a power-on state, the CPU 111 starts the processing flow illustrated in FIG. 2. In step S201, the CPU 111 executes preparation processing for the relay recording mode. FIG. 7 is a flowchart illustrating exemplary preparation processing.

In step S701, the CPU 111 detects a unique ID of a disk which is recorded in a predetermined area of the disk 109 beforehand by the disk I/F 110. The CPU 111 writes the detected unique ID to the flash memory 113. In step S702, the CPU 111 determines whether any order information is stored in the flash memory 113. The order information indicates the order of each disk that stores part of the sequential image data recorded based on the relay recording mode. The order information is not yet stored if the disk is a first disk loaded after the relay recording mode switch has been operated by a user.

If the CPU 111 determines that no order information is stored (NO in step S702), the processing flow proceeds to step S707. In step S707, the CPU 111 generates order information based on the unique ID detected in step S701 and stores the generated order information in the flash memory 113.

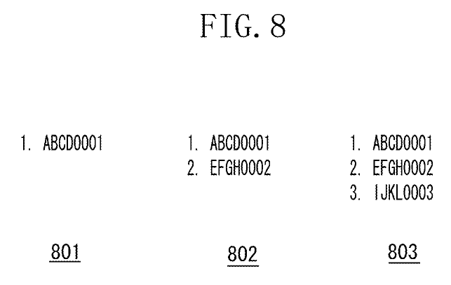

FIG. 8 illustrates an exemplary order information 801 generated in response to setting of the relay recording mode. The order information 801 includes a unique ID of a disk and a number representing the order of the disk (i.e., ABCD0001).

If the flash memory 113 stores the order information (YES in step S702), the processing flow proceeds to step S703. In step S703, the CPU 111 determines whether the unique ID detected in step S701 is already registered (described) in the order information.

If the unique ID is not yet registered in the order information (NO in step S703), the CPU 111 determines that a disk is newly loaded. In step S704, the CPU 111 adds the detected unique ID to the order information to update the contents of the order information. The processing flow then proceeds to step S705.

FIG. 8 illustrates exemplary order information 802 generated (updated) in response to loading of a second disk. The secondly loaded disk has a unique ID represented by EFGH0002. Similarly, FIG. 8 illustrates exemplary order information 803 generated (updated) in response to loading of a third disk. The thirdly loaded disk has a unique ID represented by IJKL0003. In this manner, the order information can include a numerical value representing the order of a disk and the ID information of the disk.

If in step S703, if the CPU 111 determines that the unique ID is already registered in the order information (step YES in S703), the processing flow proceeds to step S705.

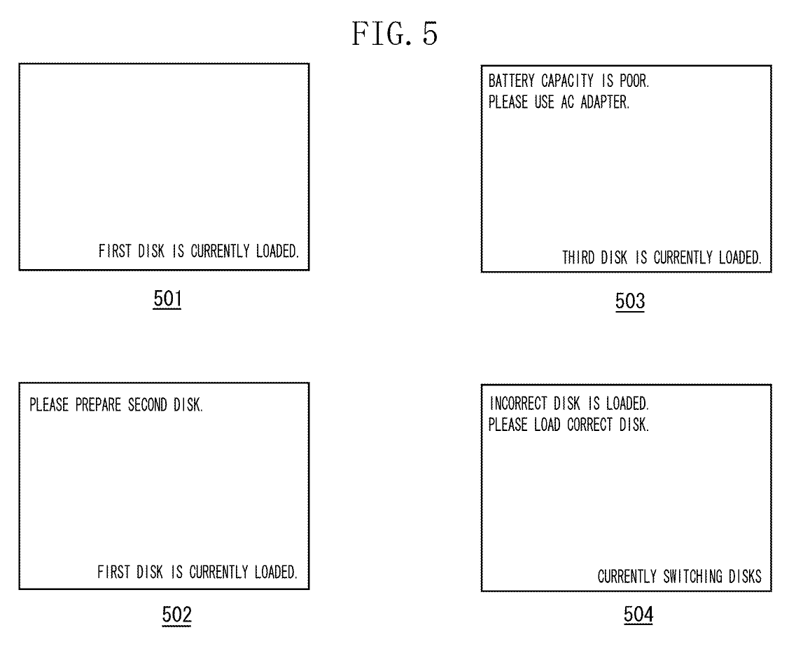

In step S705, the CPU 111 causes the display unit 106 to display information relating to the relay recording mode. FIG. 5 illustrates exemplary information that the display unit 106 can display in the relay recording mode. More specifically, if the disk is a first loaded disk, the display unit 106 displays a message 501 simply indicating the order of the disk.

Then, in step S706, the CPU 111 generates management information used in the finalization processing for the disk 109. The flash memory 113 stores the generated management information. In addition, immediately after the relay recording mode is set, or after a disk is newly loaded, the CPU 111 reserves a recording area on the disk 109 that can record moving image data produced in the relay recording mode.

After the abovementioned preparation processing is terminated, the processing flow proceeds to step S202. In step S202, the CPU 111 determines whether a recording instruction is input through the operation switch 105. If the CPU 111 determines that a recording start instruction is input (YES in step S202), the processing flow proceeds to step S203.

In step S203, the CPU 111 records the generated moving image data on the disk 109 as described above. Namely, the CPU 111 records the moving image data based on the recording format and the image quality mode stored in the flash memory 113.

In step S204, the CPU 111 detects a remaining recording capacity of the disk 109 based on the management information recorded on the disk 109. The CPU 111 determines whether the detected remaining recording capacity is equal to or less than a predetermined amount.

The predetermined amount in step S204 is a data amount corresponding to a remaining time of the disk 109 recordable at an image quality mode (data rate) currently selected. Therefore, the predetermined amount in step S204 is variable depending on the image quality mode. However, the CPU 111 can refer to a constant threshold value regardless of the selected image quality mode, if acceptable, to check the remaining recording capacity of a disk.

If the CPU 111 determines that the remaining recording capacity is equal to or less than the predetermined amount (YES in step S204), the processing flow proceeds to step S205. In step S205, the CPU 111 causes the display unit 106 to display warning information to indicate a situation where the remaining recording capacity is insufficient. FIG. 5 illustrates an exemplary message (warning information) 502 that the display unit 106 can display when the remaining recording capacity of the first loaded disk becomes insufficient during a recording operation of the disk.

In step S206, the CPU 111 determines whether the disk 109 has any remaining recording capacity. If the CPU 111 determines that there is any remaining recording capacity (YES in step S206), the processing flow proceeds to step S207.

In step S207, the CPU 111 determines whether a recording stop instruction is input through the operation switch 105. If the CPU 111 determines that no recording stop instruction is input (NO in step S207), the processing flow returns to step S203 to continue the recording operation.

If the CPU 111 determines that a recording stop instruction is input (YES in step S207), the processing flow proceeds to step S208. In step S208, the CPU 111 stops recording the image data on the disk 109. Then, in step S209, the CPU 111 updates the management information of the disk 109 stored in the flash memory 113.

Next, in step S210, the CPU 111 determines whether a finalization instruction is input through the operation switch 105. If the CPU 111 determines that a finalization instruction is input (YES in step S210), the processing flow proceeds to step S215. In the step S215, the CPU 111 executes the finalization processing in the relay recording mode as described below.

If the CPU 111 determines that no finalization instruction is input (NO in step S210), the processing flow proceeds to step S211. In step S211, the CPU 111 determines whether an ejection instruction of the disk 109 is input through the operation switch 105. If the CPU 111 determines that a disk ejection instruction is input (YES in step S211), the processing flow proceeds to step S212.

In step S212, the CPU 111 causes the ejection mechanism (not shown) to unload the disk 109 from the video camera 100. In this case, if the disk currently has no remaining recording capacity, the CPU 111 can cause the display unit 106 to display an exemplary message (warning information) 502 illustrated in FIG. 5 to recommend a user to load the next disk.

Next, in step S213, the CPU 111 determines whether a disk (second disk) 109 is newly loaded. If the CPU 111 determines that the second disk 109 is loaded (YES in step S213), the processing flow returns to step S201 to execute the preparation processing.

If, the CPU 111 determines that no disk ejection instruction is input (NO in step S211), or if no disk is newly loaded after the disk ejection operation (NO in step S213), the processing flow proceeds to step S214. In step S214, the CPU 111 determines whether a power-off instruction is input through the operation switch 105. If the CPU 111 determines that a power-off instruction is input (YES in step S214), the CPU 111 stores the information indicating that the video camera 100 is operating in the relay recording mode in the flash memory 113 and turns off the power source. On the other hand, if the CPU 111 determines that no power-off instruction is input (NO in step S214), the processing flow returns to step S202.

If the CPU 111 determines during recording of the image data that the disk 109 has no remaining recording capacity for recording image data (NO in step S206), the processing flow proceeds to step S216. In step S216, the CPU 111 stops recording the image data on the disk 109. Then, in step S217, the CPU 111 updates the management information of the disk 109 stored in the flash memory 113. The processing flow proceeds to step S212 to eject the disk 109.

In this manner, through the processing, illustrated in FIG. 2, that can record image data on plural disks according to the relay recording mode, the order information correlating the recording order or the loading order of each disk with the unique ID of the disk can be generated and stored in the flash memory 113.

Next, the finalization processing in step S215 is described in detail. It is now assumed that recording image data according to the relay recording mode requires a total of three disks and a user has input a finalization instruction through the operation switch 105.

The finalization processing can require a number of minutes to complete. Hence, if a finalization instruction is input, the present embodiment determines whether the remaining battery capacity is sufficient for completing the finalization processing. And, if the remaining battery capacity is poor, the present embodiment displays warning information 503 illustrated in FIG. 5.

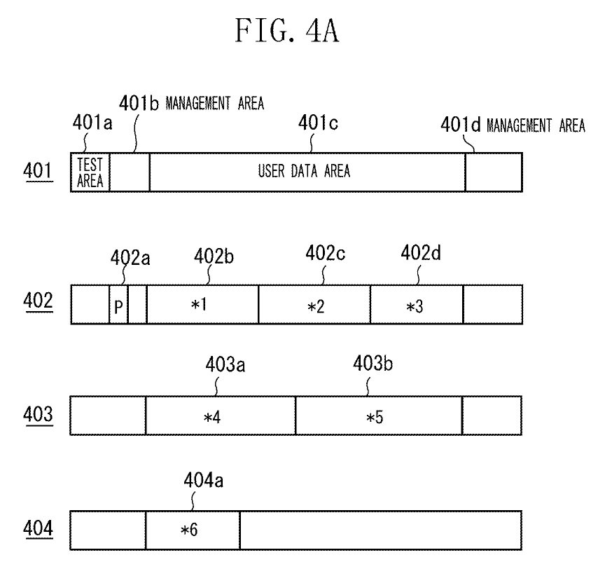

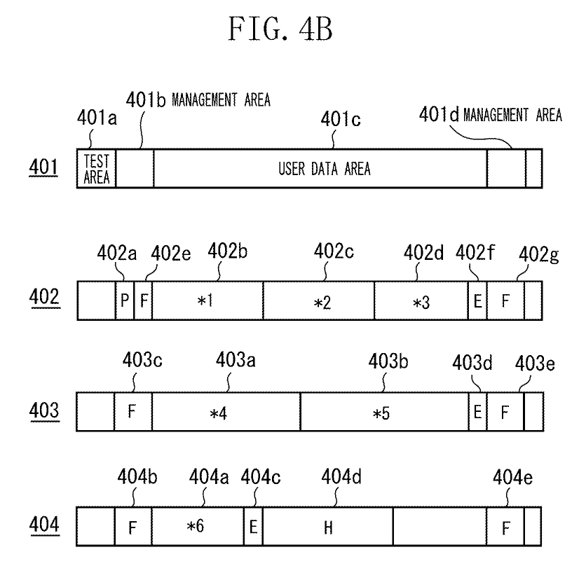

FIGS. 4A and 4B illustrate exemplary recording states of three disks storing image data recorded according to the relay recording mode. The disk 109 (refer to 401 illustrated in FIG. 4A) includes an area 401a (header) that stores light beam power adjustment data, an area 401b that stores management information, an area 401c that stores user data including image data and audio data, and an area 401d (tail) that stores management information. As illustrated in FIG. 4A, an exemplary recording of image data according to the relay recording mode ranges from first to third disks (refer to 402 through 404) in a condition where the recorded image data have not been subjected to the finalization processing.

The first disk (refer to 402 illustrated in FIG. 4A) includes a management information area 402a which is first recorded when the relay recording mode is set, in addition to plural data areas 402b, 402c, and 402d that store moving image data *1 through *3, respectively. The second disk (refer to 403 illustrated in FIG. 4A) includes two data areas 403a and 403b that store moving image data *4 and *5. The third disk (refer to 404 illustrated in FIG. 4A) includes a data area 404a that stores moving image data *6.

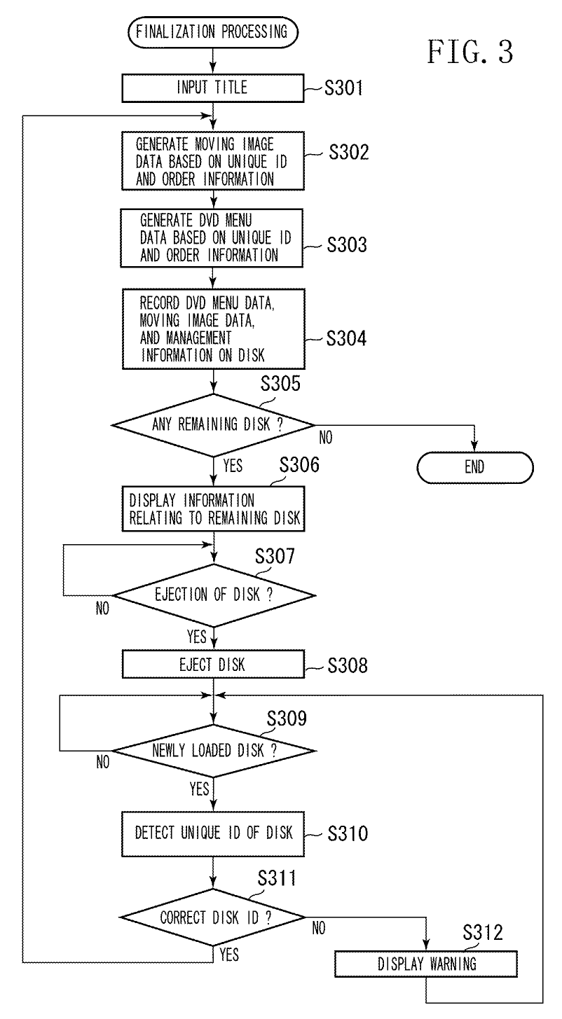

FIG. 3 is a flowchart illustrating an exemplary finalization processing. The present embodiment determines plural disks to be allocated to a same group if a finalization instruction is input after the relay recording mode is set. The CPU 111 controls various sections to execute the finalization processing illustrated in FIG. 3.

If a user instructs the finalization processing, the CPU 111 executes processing for generating a DVD menu. In step S301, a user can input a desired DVD title name on a DVD menu. For example, a user inputs “sports meeting.” Next, the CPU 111 identifies the order of a presently loaded disk based on the unique ID information of the presently loaded disk (detected in the preparation processing illustrated in FIG. 2) and the order information stored in the flash memory 113.

Then, in step S302, the CPU 111 causes the image processing circuit 114 and the moving image coding/decoding section 108 to generate moving image data representing a preceding or succeeding disk. For example, if the finalization processing is applied to a third disk, the image processing circuit 114 and the moving image coding/decoding section 108 can generate the moving image data indicating a message “Please playback a second disk.” Moreover, if the finalization processing is applied to a second disk, the image processing circuit 114 and the moving image coding/decoding section 108 can generate the moving image data indicating a message “Please playback a first disk” or “Please playback a third disk.”

Next, in step S303, the CPU 111 generates menu data based on the unique ID of the presently loaded disk and the order information. More specifically, the CPU 111 generates image data for a menu screen including a thumbnail of moving image data recorded in the currently loaded disk, a thumbnail of moving image data recorded in a preceding or succeeding disk, and the title input in step S301. In this case, the menu data generated by the CPU 111 includes information for correlating each thumbnail with recorded moving image data. Furthermore, the menu screen according to the present embodiment includes text information indicating a total number of disks having recorded moving image data based on the current relay recording mode and the order of the presently loaded disk.

Next, in step S304, the CPU 111 records the DVD menu data, the moving image data and the management information (i.e., information for managing the data recorded on the disk) to predetermined areas of the disk 109. FIGS. 4A and 4B illustrate exemplary recording areas for the data. If the above-described processing is completed for one disk, the CPU 111 stores, in the flash memory 113, the unique ID of the disk as a disk ID having been subjected to the finalization processing.

In step S305, the CPU 111 determines whether there is any disk that stores image data recorded in the relay recording mode and has not yet been subjected to the finalization processing, based on the order information stored in the flash memory 113. If the CPU 111 determines that all disks have been already subjected to the finalization processing (NO in step S305), the CPU 111 erases the order information and the disk ID of each finalized disk from the flash memory 113 and terminates the processing of this routine.

If the CPU 111 determines that there is any disk having not been subjected to the finalization processing (YES in step S305), the processing flow proceeds to step S306. In step S306, the CPU 111 detects the number of remaining disk(s) based on the order information stored in the flash memory 113 and causes the display unit 106 to display the information representing the remaining disk(s).

Next, in step S307, the CPU 111 determines whether an ejection instruction of the disk is input. If the ejection instruction is input (YES in step S307), the CPU 111 causes the ejection mechanism (not shown) to unload the disk in step S308. Then, in step S309, the CPU 111 determines whether another disk is loaded. If any disk is newly loaded (YES in step S309), the CPU 111 detects a unique ID of the newly loaded disk in step S310.

In step S311, the CPU 111 determines whether the detected unique ID is involved in the order information stored in the flash memory 113 and determines whether the disk has been already subjected to the finalization processing.

If the detected unique ID of the newly loaded disk is not involved in the order information, or if the disk has already been subjected to the finalization processing (NO in step S311), the processing flow proceeds to step S312. In step S312, the CPU 111 causes the display unit 106 to display a warning message 504 illustrated in FIG. 5. Then, the processing flow returns to step S309.

If the detected unique ID of the newly loaded disk is involved in the order information, or if the disk has not been subjected to the finalization processing (YES instepS311), the processing flow returns to step S302 to execute the above described processing.

FIG. 4B illustrates an exemplary recording state of the disk at the moment the finalization processing for all disks recorded according to the relay recording mode is terminated. In FIG. 4B, recording states 402 to 404 illustrate data areas on three disks recorded according to the relay recording mode.

Through the finalization processing, the video camera 100 can record the management information F in areas 402e, 402g, 403c, 403e, 404b, and 404e. Furthermore, the video camera 100 can record moving image data representing a preceding or succeeding disk in areas 402f, 403d, and 404c and dummy data according to the DVD video standard in area 404d.

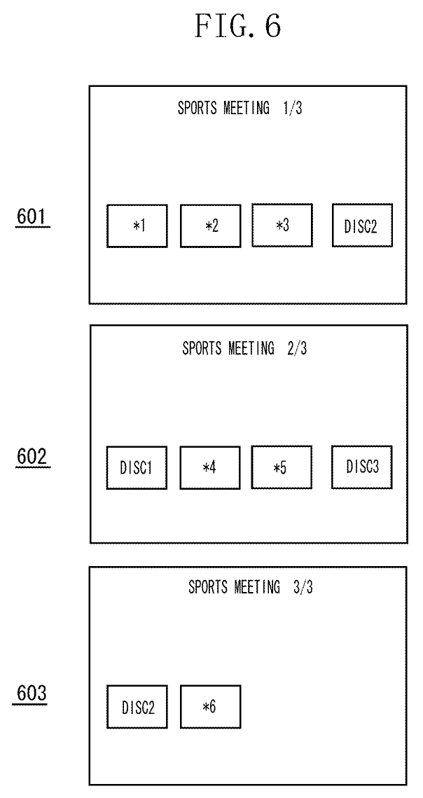

FIG. 6 illustrates menu screens of three disks which are recorded according to the relay recording mode and subjected to the finalization processing as described above. The menu screen illustrated in FIG. 6 can be displayed when each disk is played back in a DVD player.

As illustrated in FIG. 6, a title “sports meeting” input by a user can be displayed on the menu screen. A menu screen 601 for a first disk includes thumbnails *1 to *3 representing three moving image scenes recorded in the disk and a thumbnail “DISC2” representing the next disk. If a user selects one of the thumbnails *1 to *3, the video camera 100 can start a playback operation for the moving image data of the selected scene.

Furthermore, if a user selects the thumbnail “DISC2”, the video camera 100 can read the moving image data relating to the next disk from the data area 402f illustrated in FIG. 4B. For example, the video camera 100 displays a message “Please insert DISC2.”

The menu screen illustrated in FIG. 6 also includes additional information relating to the total number of disks recorded according to the relay recording mode, and the order of each disk. For example, the menu screen 601 for the first disk includes additional information “1/3”, according to which a user can easily know that there are three disks which have the same title “sports meeting” and store sequential image data recorded according to the same relay recording mode. A menu screen 602 for a second disk includes thumbnails *4 and *5 representing two moving image scenes recorded in the second disk, thumbnail “DISC1” representing the previous disk and thumbnail “DISC3” representing the next disk. And a menu screen 603 for a third disk includes thumbnail *6 representing a moving image scene recorded in the third disk and thumbnail “DISC2” representing the previous disk. The user can know the order of each disk.

In the present embodiment, instead of recording the moving image data, the video camera 100 can display a still image representing a corresponding character string, “Please insert DISC2”. Moreover, the processing in step S701 can be modified so as to detect information relating to a manufacturer of a disk and store the detected manufacturer information together with the unique ID of the disk in the flash memory 113. The manufacturer information can be included in a menu screen when a disk is subjected to the finalization processing and can be recorded on the disk. Moreover, the disk ID can include two or more information, such as a combination of a manufacturing number of a disk and a manufacturer name.

As described above, in the operation for recording sequential or related images on plural disks, the present embodiment can allocate plural disks to a same group and record, on each disk, the information relating to the order of each disk in the group. Therefore, based on a menu of each disk, a user can easily recognize the total number of disks belonging to the same group and the order of each disk.

As described above, the present embodiment regards all disks as belonging to the same group if these disks are used to record moving image data according to the DVD video mode during a period from setting of the relay recording mode to instruction of the finalization processing. However, no finalization processing is required in the VR mode. Thus, the present embodiment can determine disks belonging to a same group in response to cancellation of the relay recording mode, instead of relying on a finalization instruction. The present embodiment can successively load the disks belonging to the same group and record, on each disk, the information indicating the total number of the disks belonging to the same group and the order of each disk.

The exemplary embodiment is not limited to the above-described finalization processing that requires a user to input a DVD title name. If desirable, at the timing the relay recording mode is set, a user can input a name for a disk group to be recorded according to the set relay recording mode. Moreover, the exemplary embodiment is not limited to the above-described video camera having the recording/playback capability applicable to a DVD or other optical disk. For example, the present embodiment can be similarly implemented even if the optical disk is replaced with other recording medium such as a memory card or a magnetic disk.

If memory cards are used, no DVD menu screen is available. Therefore, the order information can be stored in a management file of the cards. In a playback operation, the display unit can display the order of cards belonging to the group and the total number of the cards based on the order information.

Each unit of the recording apparatus and each step of the recording method in the above-described embodiment of the present invention can be realized by a computer that can execute a program stored in a RAM or a ROM. Thus, the present invention encompasses program code and a computer-readable medium storing the program code.

The present invention can be implemented as a system, an apparatus, a method, a program or a storage medium. More specifically, the present invention can be applied to a system including plural devices or can be applied to a single apparatus.

Furthermore, software program code for realizing the functions of the above-described embodiment (i.e., program code corresponding to the flowcharts illustrated in FIGS. 2 and 3) can be supplied to a system or an apparatus including various devices. A computer (or CPU or micro-processing unit (MPU)) in the system or the apparatus can execute the program to operate the devices to realize the functions of the above-described embodiment. Accordingly, the present invention encompasses the program code supplied from a remote place and installable in a computer when the functions or processes of the exemplary embodiments can be realized by the computer.

In this case, the program code itself can realize the functions of the exemplary embodiment. The equivalents of programs can be used if they possess comparable functions. Furthermore, the present invention encompasses supplying the program code to a computer with as a storage (or recording) medium storing the program code. In this case, the type of program can be any one of object code, interpreter program, and OS script data. A storage medium supplying the program can be selected from any one of a floppy disk, a hard disk, an optical disk, a magneto-optical (MO) disk, a compact disk—ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the program includes accessing a web site on the Internet using the browsing function of a client computer, when the web site allows each user to download the computer program of the present invention, or compressed files of the programs having automatic installing functions, to a hard disk or other recording medium of the user.

The program code constituting the programs of the present invention can be divided into a plurality of files so that respective files are downloadable from different web sites. Namely, the present invention encompasses WWW servers that allow numerous users to download the program files so that the functions or processes of the present invention can be realized on their computers.

The programs of the present invention can be enciphered and stored on a CD-ROM or comparable recording medium when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described embodiment can be realized.

Moreover, an operating system (OS) or other application software running on the computer can execute part or all of the actual processing based on instructions of the programs. Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described embodiment can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-130098 filed May 9, 2006 and No. 2007-037003 filed Feb. 16, 2007, which are hereby incorporated by reference herein in their entirety.

What is claimed is:

1. A recording apparatus comprising:
a recording unit configured to record image data on a recording medium;
a determination unit configured to determine a plurality of recording media to be allocated to a same group;
a generation unit configured to generate order information indicating an order of each recording medium in the group, the order information including identification information identifying each recording medium;
an identification unit configured to identify a recording medium in the group based on the identification information; and
a control unit configured to control the recording unit to record, on each of the plurality of recording media belonging to the same group, information representing an order of the identified recording medium in the group and information representing a total number of the recording media belonging to the same group, based on an identification result obtained by the identification unit and the order information generated by the generation unit.

2. The apparatus according to claim 1, further comprising a setting unit configured to set a relay recording mode according to which the plurality of recording media are regarded as belonging to the same group, wherein the determination unit allocates the plurality of recording media to the same group if the plurality of recording media are used to record the image data according to the relay recording mode in a period from setting of the relay recording mode by the setting unit to cancellation of the relay recording mode.

3. The apparatus according to claim 2, further comprising a finalization instruction unit configured to instruct finalization processing applied to the recording medium, wherein the control unit cancels the setting of the relay recording mode in response to an instruction by the finalization instruction unit.

4. The apparatus according to claim 3, wherein the recording medium includes a digital versatile disk, wherein the control unit controls the recording unit to record, on the digital versatile disk, a DVD menu screen including the information representing the order in the group and information representing a total number of the recording media belonging to the same group according to the finalization instruction.

5. The apparatus according to claim 1, further comprising a detecting unit configured to detect the identification information recorded in the recording medium, wherein the generation unit includes a holding unit configured to hold the order information, wherein if the identification information detected by the detecting unit is not included in order information, the generation unit updates the order information based on the identification information detected by the detecting unit.

6. The apparatus according to claim 1, further comprising an imaging unit configured to capture an image of an object and output the image data.

7. A recording apparatus comprising:
a recording unit configured to record image data on a loaded recording medium;
a setting unit configured to set a relay recording mode according to which a plurality of recording media are regarded as belonging to a same group;
a generation unit configured to allocate a plurality of recording media to a same group if the plurality of recording media are loaded in a period from setting of the relay recording mode by the setting unit to cancellation of the relay recording mode, and generate order information representing a loading order of the recording medium in the group;
an identification unit configured to identify a recording medium in the group; and
a control unit configured to control the recording unit to record, on each of the plurality of recording media belonging to the same group, information representing an order of the identified recording medium in the group and information representing a total number of the recording media belonging to the same group, based on an identification result obtained by the identification unit and the order information generated by the generation unit.

8. A method comprising:
recording image data on a recording medium;
determining a plurality of recording media to be allocated to a same group;
generating order information indicating an order of each recording medium in the group, the order information including identification information identifying each recording medium;
identifying a recording medium in the group based on the identification information; and
recording, on each of the plurality of recording media belonging to the same group, information representing an order of the identified recording medium in the group and information representing a total number of the recording media belonging to the same group, based on an identification result and the order information.

9. A method comprising:
recording image data on a loaded recording medium;
setting a relay recording mode according to which a plurality of recording media are regarded as belonging to a same group;
allocating a plurality of recording media to a same group if the plurality of recording media are loaded in a period from setting of the relay recording mode to cancellation of the relay recording mode;
generating order information representing a loading order of the recording medium in the group;
identifying a recording medium in the group; and
recording, on each of the plurality of recording media belonging to the same group, information representing an order of the identified recording medium in the group and information representing a total number of the recording media belonging to the same group, based on an identification result and the order information.

10. A medium storing instructions which, when executed by a recording apparatus, causes the recording apparatus to perform operations, the medium comprising:
instructions for recording image data on a recording medium;
instructions for determining a plurality of recording media to be allocated to a same group;
instructions for generating order information indicating an order of each recording medium in the group, the order information including identification information identifying each recording medium;
instructions for identifying a recording medium in the group based on the identification information; and
instructions for recording, on each of the plurality of recording media belonging to the same group, information representing an order of the identified recording medium in the group and information representing a total number of the recording media belonging to the same group, based on an identification result and the order information.

11. A medium storing instructions which, when executed by a recording apparatus, causes the recording apparatus to perform operations, the medium comprising:
instructions for recording image data on a loaded recording medium;
instructions for setting a relay recording mode according to which a plurality of recording media are regarded as belonging to a same group;
instructions for allocating a plurality of recording media to a same group if the plurality of recording media are loaded in a period from setting of the relay recording mode to cancellation of the relay recording mode;
instructions for generating order information representing a loading order of the recording medium in the group;
instructions for identifying a recording medium in the group; and
instructions for recording, on each of the plurality of recording media belonging to the same group, information representing an order of the identified recording medium in the group and information representing a total number of the recording media belonging to the same group, based on an identification result and the order information.
